(19) United States
(12) Patent Application Publication
(10) Pub. No.: US 2014/0081771 A1
(43) Pub. Date: Mar. 20, 2014

(54) PUBLISHER INVENTORY EXTENSION

(71) Applicants: Alok Sheth, Clifton, NJ (US); Sean Harvey, Astoria, NY (US); Wendy Hillegass, Brooklyn, NY (US)

(72) Inventors: Alok Sheth, Clifton, NJ (US); Sean Harvey, Astoria, NY (US); Wendy Hillegass, Brooklyn, NY (US)

(73) Assignee: GOOGLE INC., Mountain View, CA (US)

(21) Appl. No.: 13/620,298

(22) Filed: Sep. 14, 2012

(51) Int. Cl. G06Q 30/02

(52) U.S. Cl. CPC G06Q 30/0277
USPC 705/14.69; 705/14.73

(57) ABSTRACT

Methods, systems, and apparatus, including computer programs encoded on a computer storage medium, for extending publisher inventory. In one aspect, a method includes receiving distribution agreement data specifying a first number of impressions that a first publisher has agreed to allocate to a content item provider during a specified period. A determination is made that an estimated total number of impressions that the first publisher will allocate to the content item provider over the specified period will be less than the first number of impressions. A third number of additional impressions are obtained from one or more second publishers that differ from the first publisher. At least a portion of the third number of additional impressions is allocated to the content item provider to meet the first number of impressions specified by the distribution agreement data.

### BACKGROUND

This specification relates to data processing and content distribution.

The Internet provides access to a wide variety of resources. For example, video and/or audio files, as well as web pages for particular subjects or that present particular news articles are accessible over the Internet. Access to these resources presents opportunities for advertisements (or other sponsored content items) to be provided with the resources. For example, a web page can include “slots” (i.e., specified portions of the web page) in which advertisements (or other content items) can be presented. These slots can be defined in the web page or defined for presentation with a web page, for example, in a separate browser window. Advertisements or other content items that are presented in slots of a resource are selected for presentation by a content distribution system that can perform an auction as part of the selection process. Additionally, or alternatively, publishers of the resources may enter into contracts with advertisers directly (e.g., without using the content distribution system), and these contracts can specify a minimum number of the advertiser's advertisements that the publisher will present over a specified period.

### SUMMARY

In general, one innovative aspect of the subject matter described in this specification can be embodied in methods that include the actions of receiving distribution agreement data specifying a first number of impressions that a first publisher has agreed to allocate to a content item provider during a specified period; determining, based on the first number of impressions and a second number of impressions that the first publisher has allocated to the content item provider during the specified period, that an estimated total number of impressions that the first publisher will allocate to the content item provider over the specified period will be less than the first number of impressions; obtaining, in response to determining that the estimated total number of impressions will be less than the first number of impressions, a third number of additional impressions from one or more second publishers that differ from the first publisher, the third number of additional impressions being based, at least in part, on a difference between the estimated total number of impression and the first number of impressions; and allocating, during the specified period, at least a portion of the third number of additional impressions to the content item provider, the portion of the third number of impressions being a number of impression required to meet the first number of impressions specified by the distribution agreement data. Other embodiments of this aspect include corresponding systems, apparatus, and computer programs, configured to perform the actions of the methods, encoded on computer storage devices.

These and other embodiments can each optionally include one or more of the following features. Obtaining the third number of impressions can include requesting the third number of impressions from an advertisement distribution system, the request specifying a maximum price that the first publisher will pay for the third number of impressions; and receiving the third number of impressions from the advertisement distribution system.

Receiving the third number of impressions from the advertisement distribution system can include receiving, by the first publisher, content item requests from the second publishers. Receiving distribution agreement data can include receiving distribution agreement data specifying one or more impression attributes that the first number of impressions are required to have; requesting the third number of impressions from the advertisement distribution system further comprises providing the advertisement distribution system with the one or more impression attributes; and receiving the third number of impressions comprises receiving impressions having the one or more impression attributes.

Receiving distribution agreement data specifying one or more impression attributes can include receiving data specifying a set of cookies; and requesting the third number of impressions comprises requesting impressions to users having a cookie that matches at least one cookie in the set of cookies.

Allocating at least a portion of the third number of impressions to the content item provider can include providing, to a user device that requests a web page for one of the second publishers, data that cause the user device to request an advertisement from an advertisement server for the first publisher.

Determining that the estimated total number of impressions will be less than the first number of impressions can include identifying, as the second number of impressions and at a particular time during the specified period, a number of impressions that the first publisher has allocated to the content item provider over an elapsed portion of the specified period, the elapsed portion of the specified period being a portion of the specified period between a beginning of the specified period and the particular time; determining an impression rate for the elapsed portion of the specified period, the impression rate specifying a rate at which the first publisher has allocated impressions to the content item provider over the elapsed portion of the specified period; determining a remaining number of impressions that the first publisher is able to provide to the content item provider over a remaining portion of the specified period, the remaining number of impressions being based on an amount of time in the remaining portion and the impression rate, the remaining portion being a portion of the specified period between the particular time and an end of the specified period; and determining, based on the estimated remaining number of impressions and the second number of impressions, that the estimated total number of impressions will be less than the first number of impressions.

Determining that an estimated total number of impressions that the first publisher will allocate to the content item provider over the specified period will be less than the first number of impressions can include identifying, as the second number of impressions, a number of on-site impressions that the publisher has already allocated to the content item provider during an elapsed portion of the specified period, the number of on-site impressions being a number of impressions, from a web-site operated by the publisher, that have been allocated to the content item provider; and determining that the second number of impressions is less than a number of impressions that were expected to have been allocated to the content item provider over the elapsed portion of the specified period.

Particular embodiments of the subject matter described in this specification can be implemented so as to realize one or more of the following advantages. A publisher system can use an advertisement distribution system to obtain additional impressions (i.e., from other publishers) when the publisher will be unable to provide a minimum required number of impressions on the publisher's properties, thereby enabling the publisher to fulfill contractual obligations to provide a minimum number of impressions. Additionally, a content item provider can be provided impressions from the other publishers without having a direct relationship with the other publishers or an advertisement distribution system that is used by the other publishers to allocate impressions.

The details of one or more embodiments of the subject matter described in this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 is a block diagram of an example environment in which content is distributed to user devices.

FIG. 2A is block diagram of an example data flow for extending publisher inventory.

FIG. 2B is a block diagram of another example data flow for extending publisher inventory.

FIG. 2C is a block diagram of another example data flow for extending publisher inventory.

FIG. 3 is a flow chart of an example process for extending publisher inventory.

FIG. 4 is a flow chart of an example process for evaluating the estimated total number of impressions.

FIG. 5 is block diagram of an example computer system.

Like reference numbers and designations in the various drawings indicate like elements.

### DETAILED DESCRIPTION

A publisher can obtain additional impressions (e.g., beyond those provided by one or more websites owned and/or managed by the publisher) from other publishers, and allocate those additional impressions to a content item provider (e.g., an advertiser) to which the publisher allocates impressions. In some implementations, the publisher obtains the additional impressions in response to a determination that a number of impressions that have been promised to the content item provider (e.g., through a content distribution agreement) is greater than a number of impressions that the publisher has contracted to provide the content item provider. For example, assume that the publisher has agreed to allocate the content item provider 1,000,000 impressions over a week, but that only 900,000 impressions will be provided by the publisher's website. In this example, the publisher may obtain 100,000 impressions from other publishers and, in turn, allocate those impressions to the content item provider.

As described in more detail below, the publisher can obtain the additional impressions from a content distribution system (e.g., an advertisement distribution system), that allocates available impressions among content item providers. For example, when the publisher determines that additional impressions will need to be obtained in order to provide the number of impressions that have been promised to the content item provider, the publisher can submit a request to the content distribution system requesting allocation of an available impression. When the publisher is allocated an available impression, the publisher can then allocate that impression to the content item provider.

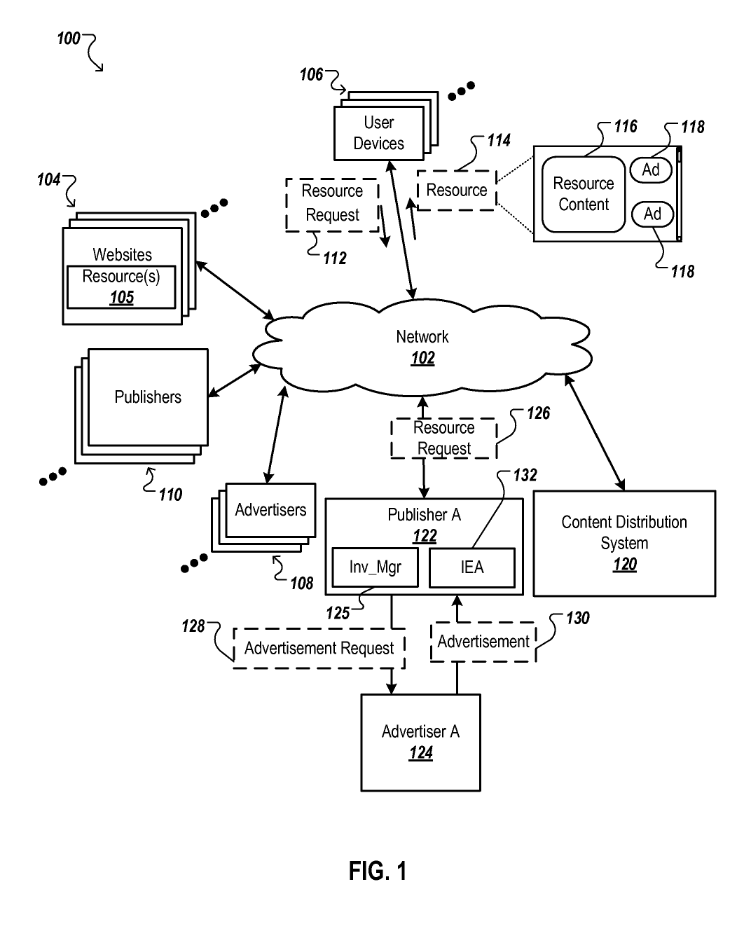

FIG. 1 is a block diagram of an example environment 100 in which content is distributed to user devices 106. The example environment 100 includes a network 102, such as a local area network (LAN), a wide area network (WAN), the Internet, or a combination thereof. The network 102 connects websites 104, user devices 106, advertisers 108, publishers 110 and the content distribution system 120. The example environment 100 may include many different websites 104, user devices 106, advertisers 108, and publishers 110.

A website 104 is one or more resources 105 associated with a domain name and hosted by one or more servers. An example website is a collection of web pages formatted in hypertext markup language (HTML) that can contain text, images, multimedia content, and programming elements, such as scripts. Each website 104 is maintained by a publisher 110, which is an entity that controls, manages and/or owns the website 104.

A resource 105 is any data that can be provided over the network 102. A resource 105 is identified by a resource address that is associated with the resource 105. Resources include HTML pages, word processing documents, and portable document format (PDF) documents, images, video, and feed sources, to name only a few. The resources can include content, such as words, phrases, images and sounds, that may include embedded information (such as meta-information in hyperlinks) and/or embedded instructions (such as scripts). Units of content that are presented in (or with) resources are referred to as content items.

A user device 106 is an electronic device that is under control of a user and is capable of requesting and receiving resources over the network 102. Example user devices 106 include personal computers, mobile communication devices, and other devices that can send and receive data over the network 102. A user device 106 typically includes a user application, such as a web browser, to facilitate the sending and receiving of data over the network 102.

A user device 106 can submit a resource request 112 that requests a resource 105 from a website 104. In turn, data representing the requested resource 114 can be provided to the user device 106 for presentation by the user device 106. The requested resource 114 can be, for example, a home page of a website 104 or another resource 105. The data representing the requested resource 114 can include data that cause presentation of resource content 116 at the user device. The data representing the requested resource 114 can also include data specifying a portion of the resource (e.g., a portion of a web page) or a portion of a user display (e.g., a presentation location of another window or in a slot of a web page) in which advertisements can be presented. Throughout this document, these specified portions of the resource or user display are referred to as advertisement slots 118, but any type of content (e.g., content items other than advertisements) can be presented in these advertisement slots 118.

When a resource 105 is requested by a user device 106, execution of code associated with an advertisement slot 118 in the resource initiates a request for an advertisement (or another type of content item) to populate the advertisement slot 118. When a resource requests an advertisement (or another content item), the resource is considered to have provided an impression. As used throughout this document, the term impression refers to a presentation opportunity for a content item. Impressions are considered to be allocated to advertisers (or other content item providers) that are selected to provide an advertisement (or another content item for presentation.

In some situations, impressions are allocated by a content distribution system 120. For example, some publishers 110 enter into an agreement to have advertisement slots 118 on their resources populated by advertisements (or other content items) selected by the content distribution system 120. In these situations, the publisher 110 will generally include, in the advertisement slots 118, code that, when executed by the user device 106, submits an advertisement request to the content distribution system 120.

The advertisement request can include characteristics of the advertisement slots 118 that are defined for the requested resource 114. For example, a reference (e.g., URL) to the requested resource 114 for which the advertisement slot 118 is defined, a size of the advertisement slot 118, and/or media types that are eligible for presentation in the advertisement slot 118 can be provided to the content distribution system 120. Similarly, keywords associated with a requested resource (“resource keywords”) can also be provided to the content distribution system 120 to facilitate identification of advertisements that are relevant to the requested resource 114. The advertisement request can further include demographic data about a user to which the advertisement will be presented, geographic information specifying a geographic location associated with the user device 106, and/or other information, such as identified user interests, with which an advertisement can be selected for presentation.

Based on data included in the advertisement request, the content distribution system 120 selects advertisements that are eligible to be provided in response to the request (“eligible advertisements”). For example, eligible advertisements can include advertisements having characteristics that match the characteristics of the advertisement slots 118 and that are identified as relevant to specified resource keywords. In some implementations, advertisements that are selected as eligible advertisements by the content distribution system 120 are those advertisements having distribution attributes (i.e., data with which distribution of the advertisement is managed) that match the resource keywords and/or the demographic/geographic information included in the advertisement

Instead of, or in addition to, relying on a content distribution system 120 to allocate its impressions among advertisers, some publishers enter directly into distribution agreements with advertisers (or other content item providers). For example, in FIG. 1, Publisher A 122 can enter into a distribution agreement with Advertiser A 124. The distribution agreement can specify a number of impressions that Publisher A 122 agrees to allocate to Advertiser A 124 over a specified period of time (e.g., 1 day, 1 month, 1 year, or any other period of time). The distribution agreement can also specify a price (e.g., a price per thousand impressions (“CPM”)) that the advertiser will pay the publisher for the impressions. During the specified period of time, when Publisher A 122 receives a resource request 126 requesting a resource that is maintained by Publisher A 122, Publisher A 122 can allocate an impression to Advertiser A 124 (independent of the content distribution system 120) by submitting an advertisement request 128 to Advertiser A 124 and presenting an advertisement 130 that Advertiser A 124 identifies, or provides, in response to the advertisement request 128.

In some situations an advertiser, such as Advertiser A 124, may want to limit the users to whom its advertisements are shown, times at which the advertisements are shown, or otherwise limit the presentation of its advertisements with resources that are maintained by Publisher A 122 (e.g., websites that are operated by Publisher A 122). Therefore, the distribution agreements can also specify particular impression attributes for impressions that are allocated to the advertiser. An impression attribute specifies a particular attribute value that the impression must have in order for the advertiser's advertisements to be eligible advertisements for the impression. For example, the impression attributes can specify that the impressions allocated to the advertiser be impressions associated with a particular demographic profile, such that the advertisements provided by the advertiser will only be eligible for presentation to users having the particular demographic profile (e.g., users of certain age groups, users having certain interests, users that work in specific industries or have specific job titles, or users having other particular demographic traits).

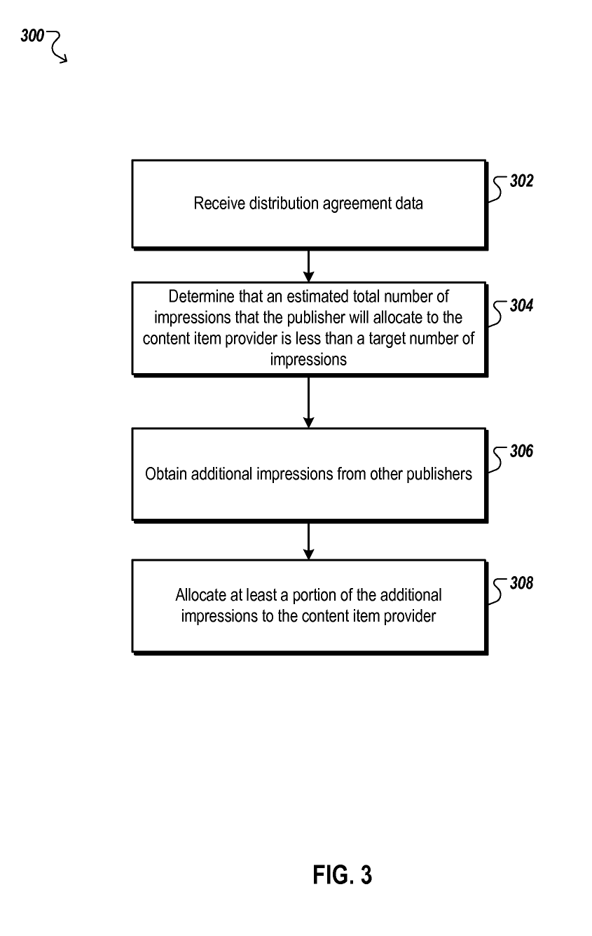

As described in more detail below with reference to FIG. 3, the impression attributes can also specify that advertisements from Advertiser A 124 are only considered eligible advertisements for impressions that are associated with a cookie (or other data) that match a cookie (or other data) in a set of cookies indicative of a particular category of user. For example, a set of cookies can be indicative of a specified user activity at resources maintained by Publisher A 122, and the impression attributes can specify that the impressions allocated to Advertiser A 124 should be impressions to users associated with the set of cookies.

The impression attributes can also specify periods of time during which the advertiser's advertisement is eligible to be presented (e.g., between 8 am and 5 pm or Monday through Friday). For example, if the impression attributes specify that advertisements from Advertiser A 124 are only eligible to be presented between 8 am and 5 pm, impressions allocated to Advertiser A 124 at times outside of the period between 8 am and 5 pm will generally not count toward the number of impressions that Publisher A 122 has agreed, under the distribution agreement, to allocate to Advertiser A 124.

To manage the allocation of impressions among one or more advertisers with which Publisher A 122 has entered into a distribution agreement, Publisher A 122 (and other publishers 110) can utilize a publisher inventory manager 125 (“Inv_Mgr”). The publisher inventory manager is a data processing apparatus that determines, for each request of a resource managed by the publisher, which advertiser will be allocated an impression that is provided by the resource.

For example, upon receipt of a resource request 126, the publisher inventory manager 125 can evaluate attributes of the resource request 126. Based on this evaluation, the publisher inventory manager 125 determines whether the attributes of the resource request meet the impression attributes specified in the distribution agreement with Advertiser A 124 (or another advertiser). If the impression attributes are met by the attributes of the resource request, the publisher inventory manager 125 will allocate an impression to Advertiser A 124, for example, by submitting the advertisement request 128 to Advertiser A 124. In turn, the impression will be counted toward fulfillment of the distribution agreement. If the impression attributes are not met by the attributes of the resource request, the publisher inventory manager 125 may still submit the advertisement request 128 to Advertiser A 124, but the terms of the distribution agreement may preclude allocation of this impression to Advertiser A 124 from being counted toward fulfillment of the distribution agreement.

The publisher inventory manager 125 can be maintained and/or operated by the publisher directly, or the publisher can contract with an inventory management service provider that will manage allocation of impressions among advertisers with which the publisher has entered into a distribution agreement. For brevity, throughout this document, the publisher inventory manager 125 is considered to be operated on behalf of the publisher, such that operations performed by the publisher inventory manager 125 will be described as being performed by the publisher.

In some situations, a publisher that has entered into a distribution agreement with an advertiser may be unable to provide a particular advertiser with the number of impressions that are required by the distribution agreement. For example, assume that during a particular period (e.g., 1 week) resources maintained by Publisher A 122 experience a lower level of traffic from users having a particular demographic profile (e.g., C-level executives). In this example, it may be that, due to the lower level of traffic, Publisher A 122 is not able to provide all of the C-level executive impressions that were requested by Advertiser A 124.

In other situations, a new advertiser may want more impressions than a particular publisher can provide on their own resources. In these situations, the particular publisher may have to pass on the opportunity to enter into a distribution agreement, or the advertiser may be required to accept fewer impressions, unless the publisher can increase the number of impressions that are available to be provided to the advertiser.

Publishers can increase the number of impressions that are available for allocation to advertisers using an inventory extension apparatus 132 (“IEA”). An inventory extension apparatus is a data processing apparatus that, for a particular publisher, obtains additional impressions (e.g., impressions beyond the impressions provided by resources maintained by the particular publisher) from other publishers. The inventory extension apparatus 132 can be implemented by Publisher A 122 (or another publisher), as part of the publisher inventory manager 125, or as a separate data processing apparatus that is accessible over the network 102. For purposes of this document the inventory extension apparatus 132 is considered to be part of the publisher inventory manager 125, and like the publisher inventory manager, operations performed by the inventory extension apparatus 132 will be described as being performed by the publisher.

The inventory extension apparatus 132 can obtain impressions from the content distribution system 120 or another source. For example, assume that Publisher A 122 needs additional impressions to fulfill its obligations under the distribution agreement with Advertiser 124. In this example, the inventory extension apparatus 132 can request, from the content distribution system 120, allocation of additional impressions (e.g., from other publishers 110). In turn, Publisher A 122 (e.g., by way of the publisher inventory manager 125) can allocate the additional impressions that are provided by the content distribution system 120 to Advertiser A 124. Thus, Publisher A 122 is able to provide Advertiser A 124 with the number of impressions specified by the distribution agreement even when resources managed directly by Publisher A 122 may not be able to provide the number of impressions.

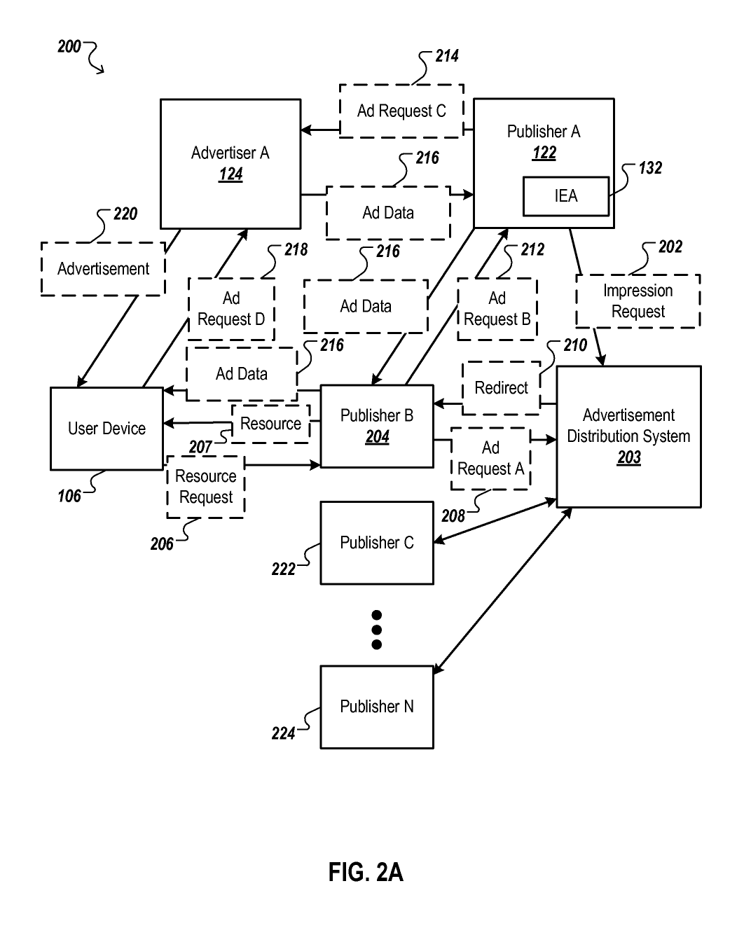

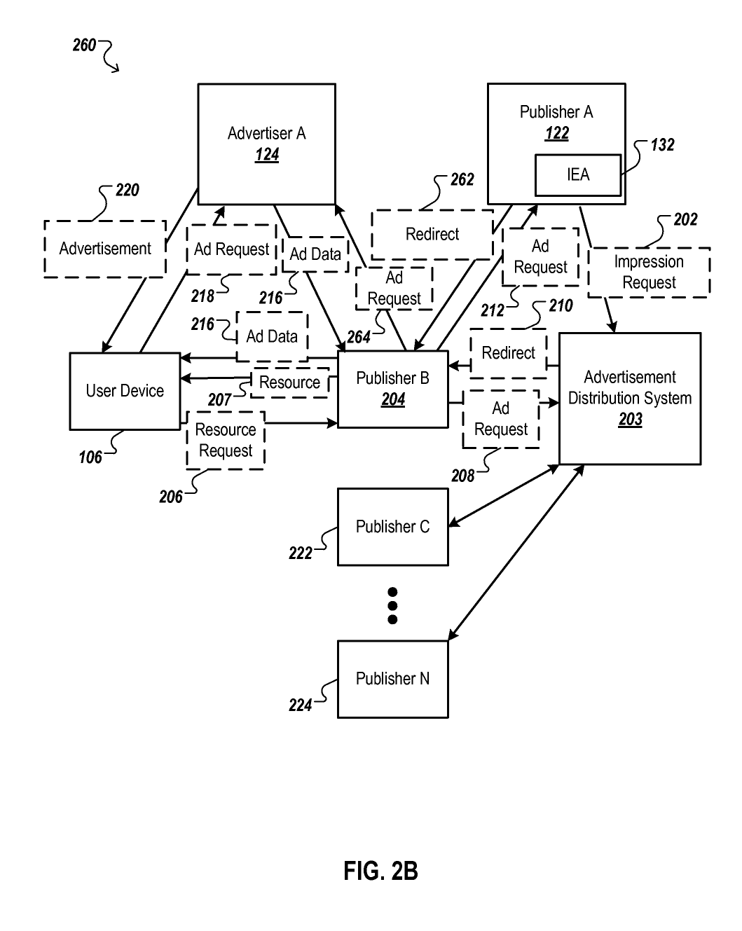

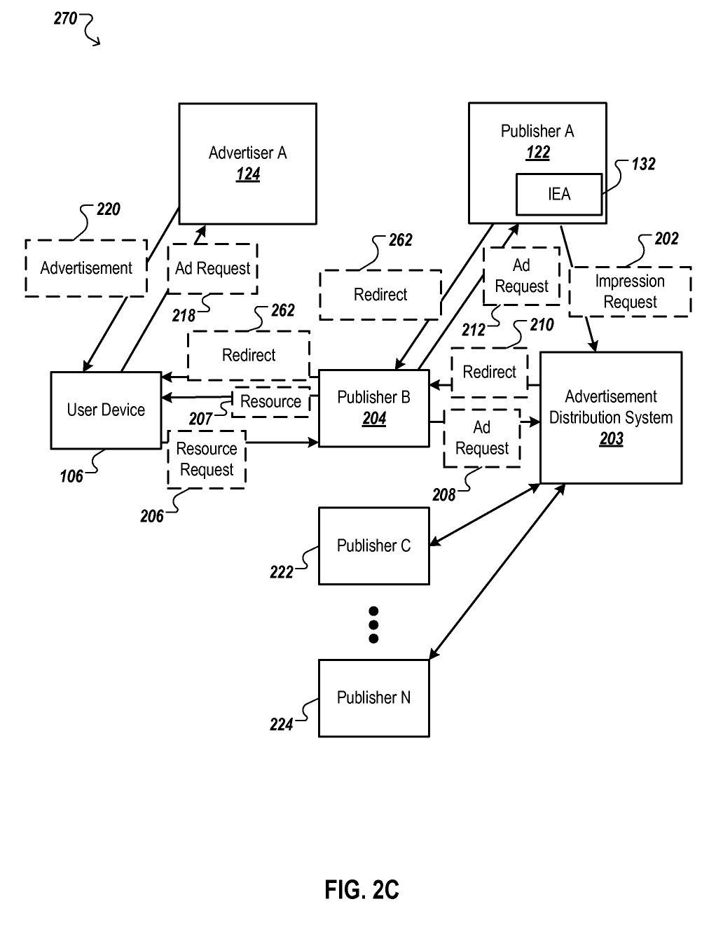

FIG. 2A is block diagram of an example data flow 200 for extending publisher inventory. The data flow 200 begins with Publisher A 122 submitting an impression request 202 (e.g., by way of the inventory extension apparatus 132) to the Advertisement Distribution System 203, which is a content distribution system that distributes advertisements. The impression request 202 can include, for example, impression attributes of impressions that are being requested by Publisher A 122. For example, assume that Publisher A 122 is submitting the impression request 202 in an effort to fulfill the terms of the distribution agreement with Advertiser A 124. In this example, the impression request 202 can include impression attributes (e.g., demographic requirements, time of day requirements, or other impression attributes) that match the impression attributes specified by Advertiser A 124. The impression request 202 can also specify a price that Publisher A 122 will pay for an impression (or a set of impressions) that is allocated to Publisher A 122.

In some implementations, the inventory extension apparatus 132 submits the impression request by scheduling, with the content distribution system 120, a campaign for the publisher. For example, upon determining that Publisher A 122 will be unable to fulfill its impression obligations, the inventory extension apparatus 132 can transmit campaign data to the content distribution system 120. The campaign data can specify a number of impressions that are being requested by Publisher A 122, a time period over which Publisher A 122 requires delivery of the requested impressions, and other data required to schedule a campaign with the content distribution system 120. This campaign can be scheduled automatically without intervention by Publisher A 122.

The data flow continues with Publisher B 204 receiving a resource request 206 from the user device 106. In response to receiving the resource request 206, Publisher B 204, provides the user device 106 with the requested resource 207 and submits an advertisement request 208 (“Ad Request A”) to the advertisement distribution system 203.

In response to receiving the advertisement request 208, the advertisement distribution system 203 can conduct an auction, or use another selection technique, to select a source of an advertisement (or another content item) that will be provided with the requested resource 207. For purposes of example, assume that the advertisement distribution system 203 performs an auction to determine the source of the advertisement that will be provided in response to the advertisement request 208. Further assume that Publisher A 122 is the winner of the auction (e.g., based on the price that Publisher A will pay for an impression). In this example, the advertisement distribution system 203 selects Publisher A 122 as the source of the advertisement that will be provided in response to the advertisement request 208.

The data flow 200 continues with the advertisement distribution system 203 providing, in response to the advertisement request 208, redirect data 210 to Publisher B 204. The redirect data 210 will identify Publisher A 122 as the source of the advertisement that will be provided with the requested resource. In some implementations, the redirect data 210 will cause Publisher B 204 to submit advertisement request 212 (“Ad Request B”) to Publisher A 122. In response to receiving advertisement request 212, Publisher A 122 (e.g., by way of inventory management apparatus 125), will allocate the impression to Advertiser A 124, for example, by submitting an advertisement request 214 (“Ad Request C”) to Advertiser A 124.

In some implementations, Advertiser A 124 can transmit, in response to receiving the advertisement request 214, advertisement data 216 (“Ad Data”) to Publisher A 122. The advertisement data 216 can include data specifying an advertisement and/or a location of an advertisement to be presented with the requested resource. For example, the advertisement data 216 can specify a particular advertisement that Advertiser A 124 will provide in response to the advertisement request 214 (e.g., based on impression attributes that are included in the advertisement request 214) and/or a uniform resource locator identifying Advertiser A 124 as the source of the particular advertisement.

Upon receipt of the advertisement data 216, Publisher A 122 can transmit the advertisement data 216 (or a modified version thereof) to Publisher B 204. In turn, Publisher B 204 can transmit the advertisement data 216 (or a modified version thereof) to the user device 106. When the user device 106 receives and/or executes instructions in the advertisement data, the user device 106 can initiate an advertisement request 218 (“Ad Request D”) to retrieve the particular advertisement specified in the advertisement data 216.

For example, if the advertisement data 216 specify that the particular advertisement is hosted by Advertiser A 124, the user device 106 can submit an advertisement request 218 to Advertiser A 124 in which the user device requests that Advertiser A 124 provide the particular advertisement identified in the advertisement request 218.

In response to receiving the advertisement request 218, Advertiser A 124 provides the user device with the advertisement 220 that was identified in in the advertisement request 218. In turn, the user device 106 renders and presents the advertisement with the resource provided by Publisher B 204.

The foregoing description refers to Publisher A 122 and Publisher B 204. However, additional publishers, such as Publisher C 222 through Publisher N 224 can each be a publisher, like Publisher B 124, that submits an advertisement request to the advertisement distribution system 110 or a publisher, like Publisher A 122, that submits an impression request 202 to the advertisement distribution system. Thus, a publisher, such as Publisher A 122, can utilize the advertisement distribution system 110 to obtain additional impression inventory (e.g., beyond the impression inventory provided by the publisher's properties) from multiple different publishers, such as publisher B 204, Publisher C 222, or Publisher N 224.

FIG. 2B is a block diagram of another example data flow 260 for extending publisher inventory. The data flow 260 differs from that described above with reference to FIG. 2A, for example, because in response to receiving the advertisement request 212, Publisher A 122 provides redirect data 262 to Publisher B 204 rather than submitting an advertisement request 214 to Advertiser A, as illustrated in FIG. 2A. The redirect data 262 causes Publisher B 204 to submit an advertisement request 264 to Advertiser A 124. In response to receiving the advertisement request 264, Advertiser A 124 provides Publisher B 204 with advertisement data 216. Publisher B 204 then provides the advertisement data 216 to the user device 106. As described above, the advertisement data 266 causes the user device 106 to submit an advertisement request 218 to Advertiser A 124. In response to the advertisement request 218, Advertiser A 124 provides the advertisement 220 to the user device 106.

FIG. 2C is a block diagram of another example data flow 270 for extending publisher inventory. The data flow 270 differs from that described above with reference to FIGS. 2A and 2B, for example, because in response to receiving the redirect data 262, Publisher B provides the redirect data 262 to the user device 106. In response to receiving the redirect data 262, the user device 106 submits the advertisement request 218 to Advertiser A 124 and receives from Advertiser A 124 the advertisement.

FIG. 3 is a flow chart of an example process 300 for extending publisher inventory. Operations of the process 300 can be implemented, for example, by a data processing apparatus, such as the inventory extension apparatus 132 of FIG. 1. The process 300 can also be implemented as instructions stored on computer storage medium such that execution of the instructions by a data processing apparatus cause the data processing apparatus to perform the operations of the process 300.

Distribution agreement data are received (302). In some implementations, the distribution agreement data can specify a particular number of impressions that a particular publisher has agreed to allocate to a content item provider (e.g., an advertiser) over a specified period. For example, the particular publisher may agree to provide the content item provider with 1,000,000 impressions over a week long period.

The distribution agreement data can also specify impression attributes that some or all of the particular number of impressions must have in order for allocation of those impressions to count toward fulfillment of the distribution agreement. In some implementations, the impression attributes can include times of day (or other periods of time) at which the impressions must be allocated to the content item provider. For example, the content item provider may only be interested in impressions from 9 am to 5 pm Monday through Friday. In this example, the distribution agreement could specify that only those impressions that are allocated to the content item provider Monday through Friday and between the hours of 9 am and 5 pm will count toward fulfilling the terms of the distribution agreement.

The impression attributes can further specify audience characteristics that an impression must have for the impression to count towards fulfillment of the distribution agreement. For example, the impression attributes can require that impressions allocated to the content item provider be impressions to users that are within a specified age range (e.g., 18-35), users that are located in a particular geographic region (e.g., users from California), users that have a minimum level of income (e.g., users that earn at least $50,000/year), users that have a particular job title (e.g., users that are doctors), and/or users that have viewed specific resources or utilize particular online resources.

In some implementations, audience characteristics are explicitly provided by the users, for example, through information that the users provide when they create a profile for a particular online service, such as a social/business networking site. Audience characteristics can also be obtained based on user activity on the publisher's sites. For example, when a user visits a particular page provided by a publisher, a new cookie can be placed on the user's device, or a cookie that has been previously placed on the user's device can be updated to include data indicating that the user has visited the particular page. Audience characteristics can be anonymized, for example, so that personally identifiable information is not included in the audience characteristics.

In some implementations, the impression attributes that are included in the received distribution agreement data specify a set of cookies that must be associated with impressions that are allocated to the content item provider in order for the impressions to count toward fulfillment of the distribution agreement. For example, a content item provider can specify, in the distribution agreement that impressions that are allocated to the content item provider should be impressions to users that are requesting, or have previously requested, a particular page of the publisher's site.

To fulfill this requirement, the publisher can create a list of cookies that have been placed on user devices that have requested the particular page and use this list to identify users that have previously requested the particular page. For example, when the publisher receives a resource request, the publisher can identify the publisher's cookie that has been placed on the user device from which the request was received. The publisher can then determine whether the identified cookie is included in the list of cookies for users that have previously requested the particular page. If the cookie is included in the list, the impression will count toward fulfillment the distribution agreement with the content item provider. If the cookie is not included in the list, the impression will not count toward fulfillment of the distribution agreement.

The distribution agreement data can also specify one or more amounts that the content item provider will pay the particular publisher for impressions that the particular publisher allocates to the content item provider. In some implementations, the price that the content item provider will pay may differ based on a source of the impression. For example, the distribution agreement data can specify that the content item provider is willing to pay $20 CPM for impressions on a resource that is operated by the particular publisher, and willing to pay $8 CPM for impressions on other resources that are not operated by the particular publisher. In this example, if the particular publisher allocates, to the content item provider, 1,000 impressions on resources that are operated by the particular publisher, the content item provider will pay the particular publisher $20. However, if the particular publisher obtains 1,000 impressions from another publisher (e.g., by way of an inventory extension apparatus) and allocates these 1,000 impressions to the content item providers, the content item provider will pay the particular publisher $8.

A determination is made that an estimated total number of impressions that the publisher will allocate to the content item provider is less than a target number of impressions for a content item provider (304). The target number of impression can be, for example, the particular number of impressions that the particular publisher has agreed to allocate to the content item provider over the specified period. Continuing with the example above, the target number of impressions can be the 1,000,000 impressions that the particular publisher agreed to provide to the content item provider.

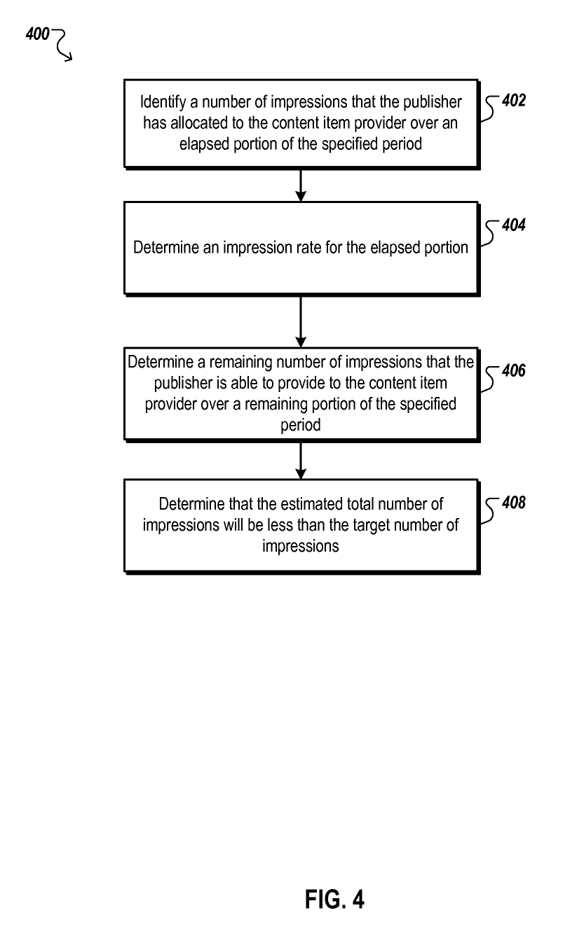

As described in more detail below with reference to FIG. 4, the determination that the estimated total number of impressions is less than the target number of impressions can be based, at least in part, on a number of impressions that have been allocated to the content item provider during an elapsed portion of the specified period. For example, the number of impressions that have been allocated to the content item provide and a duration of the elapsed portion of the specified period can be used to determine an impression rate, which can be used to determine an expected number of impressions that the publisher will be able to provide the content item provider over the remaining portion of the specified period. The estimated total number of impressions (e.g., a sum of the number of impressions allocated during the elapsed portion and the expected number of impressions that will be provided by the publisher over the remaining portion) can then be compared to the target number of impressions to determine whether the estimated total number of impressions for the specified period is less than the target number of impressions.

In response to determining that the estimated total number of impressions is less than the target number of impressions, additional impressions are obtained from other publishers (306). In some implementations, the number of additional impressions that are obtained is based on a difference between the target number of impressions and the estimated total number of impressions. For example, assume that a publisher has agreed to allocate 1,000,000 impressions to a content item provider, such that the target number of impressions for the publisher is 1,000,000 impressions. Further assume that the estimated total number of impressions for the publisher is 900,000 impressions. In this example, the publisher may obtain 100,000 additional impressions from one or more other publishers in order to allocate the target number of impressions to the content item provider.

In some implementations, the number of additional impressions can be determined based on a difference between the number of impressions that the publisher has already allocated to the content item provider during an elapsed portion of the specified period, and a target number of impressions that were expected to have been allocated to the content item provider over the elapsed portion of the specified period. For example, assume that after two days of a one week period, the publisher was expected to have provided 2,000 out of 5,000 impressions (e.g., 1,000 impressions per day), but that after two days, the publisher has only allocated 1,000 impressions to the content item provider. In this example, the additional number of impressions may be set to 1,000 impressions.

The additional impressions can be obtained from an advertisement distribution system. In some implementations, the publisher submits an impression request to the advertisement distribution system. The impression request can include data specifying a number of additional impressions that the publisher is requesting. Continuing with the example above, the impression request can indicate, for example, that the publisher is requesting 100,000 additional impressions from the advertisement distribution system.

The impression request can also include impression attributes (e.g., demographic requirements, time of day requirements, or other impression attributes) that match the impression attributes specified by the distribution agreement data. In some implementations, the impression attributes include data specifying a set of cookies that can be used to identify impressions being requested by the publisher. For example, the advertisement distribution system can determine whether a user device at which the impression will occur has a cookie that matches one of the cookies in the set of cookies. If a match is detected, the advertisement distribution system can identify that particular impression as an impression that has been requested by the publisher.

In some implementations, the impression request can be submitted by way of the impression extension apparatus scheduling a campaign with the advertisement distribution system. The campaign can specify, among other things, the additional number of impressions required by the publisher and a time period over which delivery of the impressions must occur. The campaign can be periodically updated and/or additional campaigns can be created based on changes to the additional number of impressions that have been determined to be required.

Continuing with an example from above, assume that at a first point in time during the specified period (e.g., after two days of a five day period), the additional number of impressions required to be delivered to the publisher over the next day is 1,000 impressions. Further assume that at a second point in time (e.g., after three days of the five day period), that the additional number of impressions that are required to be delivered to the publisher over the next day is 500 impressions. In this example, the campaign that was initially created may have specified that 1,000 impressions needed to be delivered to the publisher over a one day period, such that at the end of the third day, this campaign could be modified to specify that 500 daily impressions need to be delivered to the publisher.

Alternatively, at the end of the third day, the impression extension apparatus could create a new campaign specifying that the publisher requires 500 impressions from the advertisement distribution over the next day. Thus, the impression extension apparatus can actively manage campaigns created at the advertisement distribution system for the publisher without requiring the publisher to actively manage the campaigns and without requiring the publisher to access a separate campaign management interface provided by the advertisement management system.

To determine whether the publisher will receive a particular impression in response to the impression request, the advertisement distribution system can conduct an auction, or use another selection technique, to select a source of a content item for the impression. Therefore, the impression request can further include a maximum price (e.g., a CPM price) that the publisher will pay for the requested impressions. For example, if the publisher will receive $8 CPM for the additional impressions, the publisher may be willing to pay up to $8 CPM in order to obtain the additional impressions so that the publisher will fulfill the terms of the distribution agreement. In this example, the impression request can include data specifying the maximum price of $8 CPM (or less). In turn, the advertisement distribution system determines whether the maximum price specified by the publisher makes the publisher the winning bidder. If the publisher is identified as the winning bidder, the advertisement distribution system will allocate the particular impression to the publisher.

As described above with reference to FIGS. 2A-2C, the advertisement distribution system can allocate a particular impression to a requesting publisher (i.e., a publisher that submitted the impression request), for example, by providing the publisher that is providing the additional impression with redirect data. The redirect data cause the publisher that is providing the additional impression to submit a content item request to the requesting publisher, such that the requesting publisher receives a content item request from the publisher that is providing the additional impression.

At least a portion of the additional impressions are allocated to the content item provider during the specified period (308). As described with reference to FIG. 2A, a requesting publisher (e.g., Publisher A 122) can allocate impressions to the content item provider (e.g., Advertiser A 124), for example, by submitting a content item request (e.g., an advertisement request) to the content item provider. As described with reference to FIG. 2B, the requesting publisher may alternatively cause the publisher that is providing the additional impression to submit a content item request to the content item provider, for example, by providing redirect data to the publisher that is providing the impression. The redirect data cause the publisher that is providing the impression to submit a content item request to the content item provider.

The number of additional impressions obtained by the publisher may be greater than or less than the difference between the target number of impressions and the estimated total number of impressions. For example, a publisher may obtain more additional impressions than are expected to be needed to provide the target number of impressions, thereby increasing the likelihood that the publisher will provide the target number of impressions. If a portion of the additional impressions remain unallocated after allocating the target number of impressions to the content item provider, the publisher can allocate the remaining impressions to the content item provider, or the publisher can utilize the remaining impressions by promoting the publisher's website.

FIG. 4 is a flow chart of an example process 400 for evaluating the estimated total number of impressions. For example, the process 400 can be used to determine that the estimated total number of impressions to be provided by a publisher will be less than a target number of impressions. Operations of the process 400 can be implemented, for example, by a data processing apparatus, such as the inventory extension apparatus 132 of FIG. 1. The process 400 can also be implemented as instructions stored on computer storage medium such that execution of the instructions by a data processing apparatus cause the data processing apparatus to perform the operations of the process 400.

A number of impressions that the publisher has allocated to a content item provider is identified (402). In some implementations, the number of impressions identified is the number of impressions that the publisher has provided over an elapsed portion of a specified period. The elapsed portion of the specified period is a portion of the specified period between a beginning of the specified period and a particular time. For example, the elapsed portion of a specified period that begins at noon on Monday and ends at noon on Friday can be the portion of the specified period between noon Monday and a current time (e.g., a time prior to noon on Friday at which the number of impressions is being identified). The number of impressions that the publisher has allocated can be identified from a data store in which data specifying the number of allocated impressions are stored, and this data store can be updated each time the publisher allocates an impression to the content item provider.

In some implementations, the number of impressions that the publisher has already provided can be determined based only on those on-site impressions that that publisher has provided to the content item provider. An on-site impression is an impression on a web site (or a resource) that is maintained and/or operated by the publisher. For example, on-site impressions provided by an owner of example.com will be those impressions on resources that are included in the domain example.com. On-site impressions can, depending on the terms of the distribution agreement, include impressions on two or more different web sites that are owned and/or operated by a same publisher.

An impression rate is determined for the elapsed portion (404). In some implementations, the impression rate specifies a rate at which the first publisher has allocated impressions to the content item provider over the elapsed portion of the specified period. Continuing with the example above, assume that the elapsed portion of the specified period is the period from Monday at noon to Wednesday at noon. In this example, the impression rate can be determined by computing a ratio of the number of impressions that the publisher has allocated to the content item provider over the elapsed period and a duration of the elapsed period. For example, the impression rate can be specified as a number of impressions per day, a number of impressions per hour, or another measure of impressions relative to time.

A remaining number of impressions that the publisher is able to provide is determined (406). In some implementations, the remaining number of impressions that the publisher is able to provide is determined for a remaining portion of the specified period. The remaining portion of the specified period is a portion of the specified period between the particular time and an end of the specified period. Continuing with the example above, at noon on Wednesday, the remaining portion of the specified period will be the portion of the specified period between noon Wednesday and noon Friday.

The remaining number of impressions that the publisher is able to provide over the remaining portion of the specified period can be computed, for example, based on the impression rate and a duration of the remaining portion of the specified period. Continuing with the example above, assume that at noon on Wednesday the impression rate is determined to be 150,000 impressions per day. In this example, the duration of the remaining portion is two days (i.e., noon Wednesday to noon Friday). Thus, the remaining number of impressions could be computed to be 300,000 impressions (i.e., 150,000 impressions/day*2 days).

Additionally, or alternatively, the remaining number of impressions can be based on seasonality data that specify changes in impression volume over time, impression volume trending information over a particular period of time, or knowledge of certain upcoming events that will likely lead to an increase in a number of impressions for a particular type of website. Other forecasting methods can also be used to estimate the remaining number of impressions.

A determination is made that the estimated total number of impressions will be less than the target number of impressions (408). In some implementations, the estimated total number of impressions is determined by summing the number of impressions that the publisher has allocated over the elapsed portion and the remaining number of impressions. This estimated total number of impressions can be compared to the target number of impressions to determine with the estimated total number of impressions is less than the target number of impressions.

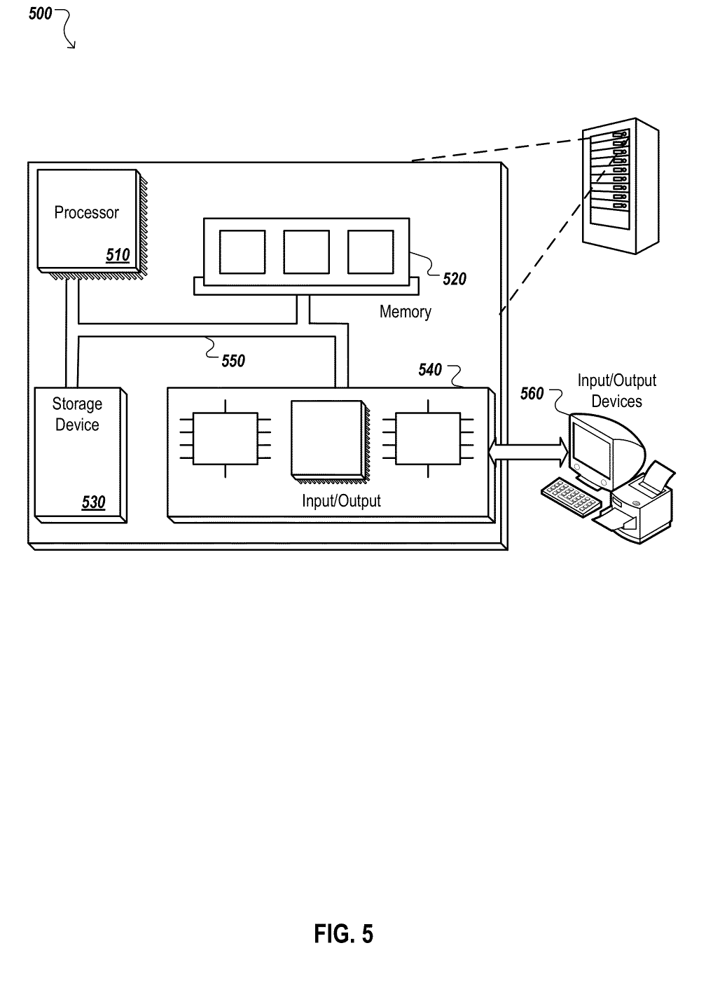

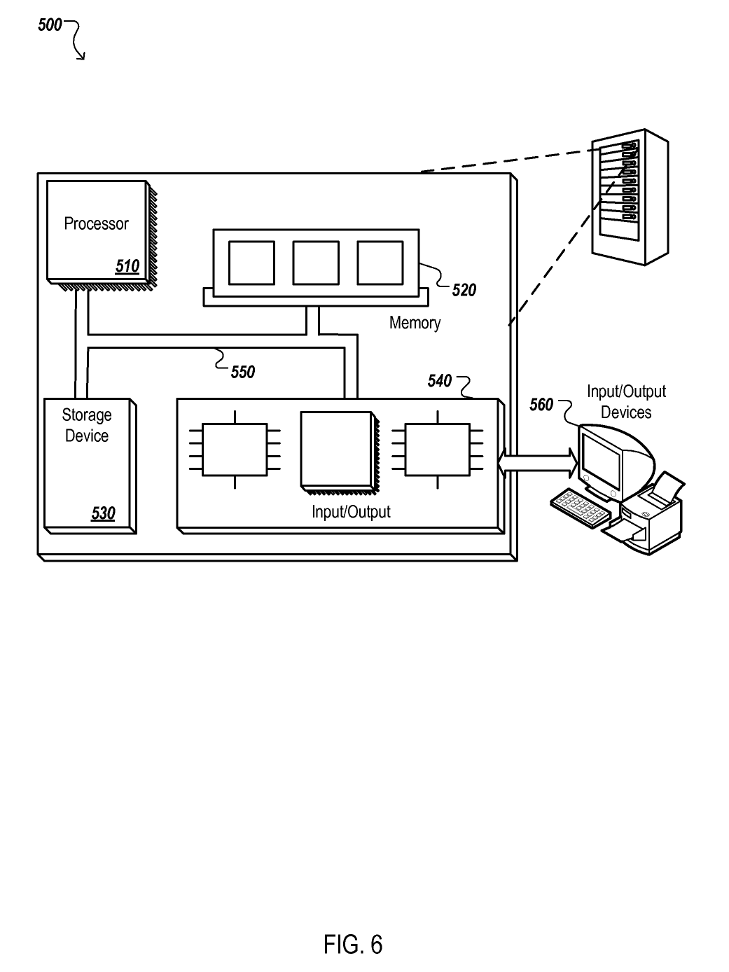

FIG. 5 is block diagram of an example computer system 500 that can be used to perform operations described above. The system 500 includes a processor 510, a memory 520, a storage device 530, and an input/output device 540. Each of the components 510, 520, 530, and 540 can be interconnected, for example, using a system bus 550. The processor 510 is capable of processing instructions for execution within the system 500. In one implementation, the processor 510 is a single-threaded processor. In another implementation, the processor 510 is a multi-threaded processor. The processor 510 is capable of processing instructions stored in the memory 520 or on the storage device 530.

The memory 520 stores information within the system 500. In one implementation, the memory 520 is a computer-readable medium. In one implementation, the memory 520 is a volatile memory unit. In another implementation, the memory 520 is a non-volatile memory unit.

The storage device 530 is capable of providing mass storage for the system 500. In one implementation, the storage device 530 is a computer-readable medium. In various different implementations, the storage device 530 can include, for example, a hard disk device, an optical disk device, a storage device that is shared over a network by multiple computing devices (e.g., a cloud storage device), or some other large capacity storage device.

The input/output device 540 provides input/output operations for the system 500. In one implementation, the input/output device 540 can include one or more of a network interface devices, e.g., an Ethernet card, a serial communication device, e.g., and RS-232 port, and/or a wireless interface device, e.g., and 802.11 card. In another implementation, the input/output device can include driver devices configured to receive input data and send output data to other input/output devices, e.g., keyboard, printer and display devices 560. Other implementations, however, can also be used, such as mobile computing devices, mobile communication devices, set-top box television client devices, etc.

Although an example processing system has been described in FIG. 5, implementations of the subject matter and the functional operations described in this specification can be implemented in other types of digital electronic circuitry, or in computer software, firmware, or hardware, including the structures disclosed in this specification and their structural equivalents, or in combinations of one or more of them.

Embodiments of the subject matter and the operations described in this specification can be implemented in digital electronic circuitry, or in computer software, firmware, or hardware, including the structures disclosed in this specification and their structural equivalents, or in combinations of one or more of them. Embodiments of the subject matter described in this specification can be implemented as one or more computer programs, i.e., one or more modules of computer program instructions, encoded on computer storage medium for execution by, or to control the operation of, data processing apparatus. Alternatively or in addition, the program instructions can be encoded on an artificially-generated propagated signal, e.g., a machine-generated electrical, optical, or electromagnetic signal, that is generated to encode information for transmission to suitable receiver apparatus for execution by a data processing apparatus. A computer storage medium can be, or be included in, a computer-readable storage device, a computer-readable storage substrate, a random or serial access memory array or device, or a combination of one or more of them. Moreover, while a computer storage medium is not a propagated signal, a computer storage medium can be a source or destination of computer program instructions encoded in an artificially-generated propagated signal. The computer storage medium can also be, or be included in, one or more separate physical components or media (e.g., multiple CDs, disks, or other storage devices).

The operations described in this specification can be implemented as operations performed by a data processing apparatus on data stored on one or more computer-readable storage devices or received from other sources.

The term “data processing apparatus” encompasses all kinds of apparatus, devices, and machines for processing data, including by way of example a programmable processor, a computer, a system on a chip, or multiple ones, or combinations, of the foregoing The apparatus can include special purpose logic circuitry, e.g., an FPGA (field programmable gate array) or an ASIC (application-specific integrated circuit). The apparatus can also include, in addition to hardware, code that creates an execution environment for the computer program in question, e.g., code that constitutes processor firmware, a protocol stack, a database management system, an operating system, a cross-platform runtime environment, a virtual machine, or a combination of one or more of them. The apparatus and execution environment can realize various different computing model infrastructures, such as web services, distributed computing and grid computing infrastructures.

A computer program (also known as a program, software, software application, script, or code) can be written in any form of programming language, including compiled or interpreted languages, declarative or procedural languages, and it can be deployed in any form, including as a stand-alone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub-programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform actions by operating on input data and generating output. The processes and logic flows can also be performed by, and apparatus can also be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processors of any kind of digital computer. Generally, a processor will receive instructions and data from a read-only memory or a random access memory or both. The essential elements of a computer are a processor for performing actions in accordance with instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device (e.g., a universal serial bus (USB) flash drive), to name just a few. Devices suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

Embodiments of the subject matter described in this specification can be implemented in a computing system that includes a back-end component, e.g., as a data server, or that includes a middleware component, e.g., an application server, or that includes a front-end component, e.g., a client computer having a graphical user interface or a Web browser through which a user can interact with an implementation of the subject matter described in this specification, or any combination of one or more such back-end, middleware, or front-end components. The components of the system can be interconnected by any form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

The computing system can include clients and servers. A client and server are generally remote from each other and typically interact through a communication network. The relationship of client and server arises by virtue of computer programs running on the respective computers and having a client-server relationship to each other. In some embodiments, a server transmits data (e.g., an HTML page) to a client device (e.g., for purposes of displaying data to and receiving user input from a user interacting with the client device). Data generated at the client device (e.g., a result of the user interaction) can be received from the client device at the server.

While this specification contains many specific implementation details, these should not be construed as limitations on the scope of any inventions or of what may be claimed, but rather as descriptions of features specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Thus, particular embodiments of the subject matter have been described. Other embodiments are within the scope of the following claims. In some cases, the actions recited in the claims can be performed in a different order and still achieve desirable results. In addition, the processes depicted in the accompanying figures do not necessarily require the particular order shown, or sequential order, to achieve desirable results. In certain implementations, multitasking and parallel processing may be advantageous.

What is claimed is:

1. A method performed by data processing apparatus, the method comprising:
receiving distribution agreement data specifying a first number of impressions that a first publisher has agreed to allocate to a content item provider during a specified period;
determining, based on the first number of impressions and a second number of impressions that the first publisher has allocated to the content item provider during the specified period, that an estimated total number of impressions that the first publisher will allocate to the content item provider over the specified period will be less than the first number of impressions;
obtaining, by a data processing apparatus and in response to determining that the estimated total number of impressions will be less than the first number of impressions, a third number of additional impressions from one or more second publishers that differ from the first publisher, the third number of additional impressions being based, at least in part, on a difference between the estimated total number of impression and the first number of impressions; and
allocating, by a data processing apparatus and during the specified period, at least a portion of the third number of additional impressions to the content item provider, the portion of the third number of impressions being a number of impression required to meet the first number of impressions specified by the distribution agreement data.

2. The method of claim 1, wherein obtaining the third number of impressions comprises:
requesting the third number of impressions from an advertisement distribution system, the request specifying a maximum price that the first publisher will pay for the third number of impressions; and
receiving the third number of impressions from the advertisement distribution system.

3. The method of claim 2, wherein receiving the third number of impressions from the advertising distribution system comprises receiving, by the first publisher, content item requests from the second publishers.

4. The method of claim 2, wherein:
receiving distribution agreement data comprises receiving distribution agreement data specifying one or more impression attributes that the first number of impressions are required to have;
requesting the third number of impressions from the advertisement distribution system further comprises providing the advertisement distribution system with the one or more impression attributes; and
receiving the third number of impressions comprises receiving impressions having the one or more impression attributes.

5. The method of claim 4, wherein:
receiving distribution agreement data specifying one or more impression attributes comprise receiving data specifying a set of cookies; and
requesting the third number of impressions comprises requesting impressions to users having a cookie that matches at least one cookie in the set of cookies.

6. The method of claim 1, wherein allocating at least a portion of the third number of impressions to the content item provider comprises providing, to a user device that requests a web page for one of the second publishers, data that cause the user device to request an advertisement from an advertisement server for the first publisher.

7. The method of claim 1, wherein determining that the estimated total number of impressions will be less than the first number of impressions comprises:
identifying, as the second number of impressions and at a particular time during the specified period, a number of impressions that the first publisher has allocated to the content item provider over an elapsed portion of the specified period, the elapsed portion of the specified period being a portion of the specified period between a beginning of the specified period and the particular time;
determining an impression rate for the elapsed portion of the specified period, the impression rate specifying a rate at which the first publisher has allocated impressions to the content item provider over the elapsed portion of the specified period;
determining a remaining number of impressions that the first publisher is able to provide to the content item provider over a remaining portion of the specified period, the remaining number of impressions being based on an amount of time in the remaining portion and the impression rate, the remaining portion being a portion of the specified period between the particular time and an end of the specified period; and
determining, based on the estimated remaining number of impressions and the second number of impressions, that the estimated total number of impressions will be less than the first number of impressions.

8. The method of claim 1, wherein determining that an estimated total number of impressions that the first publisher will allocate to the content item provider over the specified period will be less than the first number of impressions comprises:
identifying, as the second number of impressions, a number of on-site impressions that the publisher has already allocated to the content item provider during an elapsed portion of the specified period, the number of on-site impressions being a number of impressions, from a web-site operated by the publisher, that have been allocated to the content item provider; and
determining that the second number of impressions is less than a number of impressions that were expected to have been allocated to the content item provider over the elapsed portion of the specified period.

9. A system comprising:
a data store storing ; and
one or more computers coupled to the data store, the one or more computers including a data storage device storing instructions that cause the one or more computers to perform operations comprising:
receiving distribution agreement data specifying a first number of impressions that a first publisher has agreed to allocate to a content item provider during a specified period;
determining, based on the first number of impressions and a second number of impressions that the first publisher has allocated to the content item provider during the specified period, that an estimated total number of impressions that the first publisher will allocate to the content item provider over the specified period will be less than the first number of impressions;
obtaining, in response to determining that the estimated total number of impressions will be less than the first number of impressions, a third number of additional impressions from one or more second publishers that differ from the first publisher, the third number of additional impressions being based, at least in part, on a difference between the estimated total number of impression and the first number of impressions; and
allocating, during the specified period, at least a portion of the third number of additional impressions to the content item provider, the portion of the third number of impressions being a number of impression required to meet the first number of impressions specified by the distribution agreement data.

10. The system of claim 9, wherein the one or more computers obtain the third number of impressions by performing operations comprising:
requesting the third number of impressions from an advertisement distribution system, the request specifying a maximum price that the first publisher will pay for the third number of impressions; and
receiving the third number of impressions from the advertisement distribution system.

11. The system of claim 10, wherein the one or more computers receive the third number of impressions from the advertisement distribution system by performing operations comprising receiving, for the first publisher, content item requests from the second publishers.

12. The system of claim 10, wherein the one or more computers:
receive distribution agreement data by performing operations comprising receiving distribution agreement data specifying one or more impression attributes that the first number of impressions are required to have;
request the third number of impressions from the advertisement distribution system by performing operations further comprising providing the advertisement distribution system with the one or more impression attributes; and
receive the third number of impressions by performing operations comprising receiving impressions having the one or more impression attributes.

13. The system of claim 12, wherein the one or more computers:
receive distribution agreement data specifying one or more impression attributes by performing operations comprising receiving data specifying a set of cookies; and
request the third number of impressions by performing operations comprising requesting impressions to users having a cookie that matches at least one cookie in the set of cookies.

14. The system of claim 9, wherein the one or more computers allocate at least a portion of the third number of impressions to the content item provider by performing operations comprising providing, to a user device that requests a web page for one of the second publishers, data that cause the user device to request an advertisement from an advertisement server for the first publisher.

15. The system of claim 9, wherein the one or more computers determine that the estimated total number of impressions will be less than the first number of impressions by performing operations comprising:
identifying, as the second number of impressions and at a particular time during the specified period, a number of impressions that the first publisher has allocated to the content item provider over an elapsed portion of the specified period, the elapsed portion of the specified period being a portion of the specified period between a beginning of the specified period and the particular time;
determining an impression rate for the elapsed portion of the specified period, the impression rate specifying a rate at which the first publisher has allocated impressions to the content item provider over the elapsed portion of the specified period;
determining a remaining number of impressions that the first publisher is able to provide to the content item provider over a remaining portion of the specified period, the remaining number of impressions being based on an amount of time in the remaining portion and the impression rate, the remaining portion being a portion of the specified period between the particular time and an end of the specified period; and
determining, based on the estimated remaining number of impressions and the second number of impressions, that the estimated total number of impressions will be less than the first number of impressions.

16. The system of claim 9, wherein the one or more computers determine that an estimated total number of impressions that the first publisher will allocate to the content item provider over the specified period will be less than the first number of impressions by performing operations comprising:
identifying, as the second number of impressions, a number of on-site impressions that the publisher has already allocated to the content item provider during an elapsed portion of the specified period, the number of on-site impressions being a number of impressions, from a web-site operated by the publisher, that have been allocated to the content item provider; and
determining that the second number of impressions is less than a number of impressions that were expected to have been allocated to the content item provider over the elapsed portion of the specified period.

17. A computer storage medium encoded with a computer program, the program comprising instructions that when executed by data processing apparatus cause the data processing apparatus to perform operations comprising:
receiving distribution agreement data specifying a first number of impressions that a first publisher has agreed to allocate to a content item provider during a specified period;
determining, based on the first number of impressions and a second number of impressions that the first publisher has allocated to the content item provider during the specified period, that an estimated total number of impressions that the first publisher will allocate to the content item provider over the specified period will be less than the first number of impressions;
obtaining, in response to determining that the estimated total number of impressions will be less than the first number of impressions, a third number of additional impressions from one or more second publishers that differ from the first publisher, the third number of additional impressions being based, at least in part, on a difference between the estimated total number of impression and the first number of impressions; and
allocating, during the specified period, at least a portion of the third number of additional impressions to the content item provider, the portion of the third number of impressions being a number of impression required to meet the first number of impressions specified by the distribution agreement data.

18. The computer storage medium of claim 17, wherein determining that the estimated total number of impressions will be less than the first number of impressions comprises:
identifying, as the second number of impressions and at a particular time during the specified period, a number of impressions that the first publisher has allocated to the content item provider over an elapsed portion of the specified period, the elapsed portion of the specified period being a portion of the specified period between a beginning of the specified period and the particular time;
determining an impression rate for the elapsed portion of the specified period, the impression rate specifying a rate at which the first publisher has allocated impressions to the content item provider over the elapsed portion of the specified period;
determining a remaining number of impressions that the first publisher is able to provide to the content item provider over a remaining portion of the specified period, the remaining number of impressions being based on an amount of time in the remaining portion and the impression rate, the remaining portion being a portion of the specified period between the particular time and an end of the specified period; and
determining, based on the estimated remaining number of impressions and the second number of impressions, that the estimated total number of impressions will be less than the first number of impressions.

19. The computer storage medium of claim 17, wherein determining that an estimated total number of impressions that the first publisher will allocate to the content item provider over the specified period will be less than the first number of impressions comprises:
identifying, as the second number of impressions, a number of on-site impressions that the publisher has already allocated to the content item provider during an elapsed portion of the specified period, the number of on-site impressions being a number of impressions, from a web-site operated by the publisher, that have been allocated to the content item provider; and
determining that the second number of impressions is less than a number of impressions that were expected to have been allocated to the content item provider over the elapsed portion of the specified period.

20. The computer storage medium of claim 17, wherein allocating at least a portion of the third number of impressions to the content item provider comprises providing, to a user device that requests a web page for one of the second publishers, data that cause the user device to request an advertisement from an advertisement server for the first publisher.
